(19) United States
(12) Patent Application Publication
(10) Pub. No.: US 2007/0290015 A1
(43) Pub. Date: Dec. 20, 2007

(54) Vehicle-mounted GPS Pole Holder

(76) Inventor: R. David Rux, Littleton, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/424,153

(22) Filed: Jun. 14, 2006

(51) Int. Cl. B60R 9/00; B60R 11/00; B60R 7/00

(52) U.S. Cl. 224/519; 224/555

(57) ABSTRACT

Most surveyors use a GPS-enabled device when performing a land survey. To minimize the frequency with which GPS units lose their connection with a GPS satellite between survey points, the GPS unit is kept on the outside of the vehicle. Current devices that allow a GPS or survey pole to be attached to the outside of a vehicle only allow a GPS or survey pole to be mounted at the window. Embodiments of the present invention comprise a vehicle-mounted survey pole that allows the pole to be coupled to vehicle at a truck bed, a wheel-well or a trailer hitch. The embodiments comprise a rod and a vehicle-attachment bracket, the rod including a tube-clamp to couple the GPS or survey pole to the rod. The vehicle-attachment bracket couples the rod to the vehicle.

### FIELD OF THE INVENTION

This invention relates generally to vehicle-mounted survey poles and GPS systems.

### BACKGROUND

Surveying is the technique and science of accurately determining the terrestrial or 3D space position of points and the distances and angles between them. These points are usually, but not exclusively, associated with positions on the surface of the Earth, and are often used to establish land maps and boundaries for ownership or governmental purposes. Surveying is a requirement in the planning and execution of nearly every form of construction and is used extensively in designing maps and defining legal property boundaries for land ownership purposes.

Historically, land surveyors measured horizontal angles using a compass. This type of instrument was later improved upon with instruments to provide more accurate angle precision. Eventually, mounted telescopes were incorporated into a tripod device that included levels and vertical angle calibration instruments. Such devices, called theodolites, or versions thereof, could measure angles down to a fraction of a degree.

Modern surveying devices employ the use of robotic instruments and satellite positioning systems, such as the Global Positioning System (“GPS”). The new generation of survey devices has essentially moved the device from a tripod to a pole. With the use of robotic instruments, land surveyors are now able to work alone, traveling freely around a job site, unhindered by cumbersome tripod surveying instrument.

Normally, when a surveyor has to move a long distance between survey locations, the surveying device is turned off and placed in the back of a vehicle. The surveyor then drives to a new location; the device is then set up at the new location and recalibrated. Recalibration of GPS equipment between each survey location can create possible errors in survey precision and is timely—therefore increasing the cost of large survey projects.

To eliminate the need to shut down the survey device between each individual survey location, many land surveyors hold onto the survey pole through an open vehicle window when traveling from one survey location to another survey location. Performing land surveys in such a manner is dangerous and may potentially damage the survey equipment. Additionally, placing and removing the survey pole from the back of a vehicle, such as a pick-up truck bed, creates additional wear and tear on the device.

Current devices that attach GPS and survey poles to the outside of a vehicle provide inadequate options to present-day surveyors. Devices such as the SECO GPS Truck Door Bracket, manufactured and sold by SECO Manufacturing Company, Inc. of Redding, Calif., are not durable enough for prolonged use over rough terrain. Additionally, the SECO device is only able to attach to a vehicle door, partially covering the door window and creating a possibility of damaging the device when the door opens and during the constant shutting of the door. The increased amount of stress on GPS and survey units may decrease the lifespan of the device. These limitations in current devices limit the number of surveyors that use the current devices and may limit the types of projects and the lifespan of the current devices.

### SUMMARY OF THE DRAWINGS

FIG. 1 is an isometric view of a vehicle-mounted pole holder according to a first embodiment of the current invention.

FIG. 2 is a rear isometric view of a tube clamp according to one embodiment of the current invention.

FIG. 3 is an exploded isometric view of a tube clamp according to one embodiment of the current invention.

FIG. 4 is an isometric view a vehicle attachment bracket according to a first embodiment of the current invention.

FIG. 5 is an isometric view of the rod according to one embodiment of the current invention.

FIG. 6 is a cut-away isometric view of a vehicle-attachment bracket mounted to a pick-up truck bed front side wall according to a first embodiment of the current invention.

FIG. 7 is an isometric view of a vehicle-mounted pole holder according to a second embodiment of the current invention.

FIG. 8 is an isometric view of the vehicle attachment bracket, coupled locking mechanism, and a portion of the connection arm according to a second embodiment of the current invention.

FIG. 9 is an isometric view of the vehicle attachment bracket, a portion of the coupled locking mechanism, a portion of the connection arm, and a backplate section, according to a second embodiment of the current invention.

FIG. 10 is an isometric view of the connection arm and integrated first backplate attached to a vehicle according to a second embodiment of the current invention.

FIG. 11 is an isometric view of a vehicle-mounted pole holder in a substantially vertical position according to a third embodiment of the current invention.

FIG. 12 is an isometric view of a vehicle-mounted pole holder in a substantially horizontal position according to a third embodiment of the current invention.

FIG. 13 is an exploded isometric view of a trailer hitch attachment and a portion of the vehicle attachment bracket according to a third embodiment of the current invention.

FIG. 14 is a partially exploded isometric view of a hinge, a portion of a vehicle attachment bracket, and a vertical stabilizer according to a third embodiment of the current invention.

FIG. 15 is a cut-away isometric view of a portion of a vehicle attachment bracket, a portion of a trailer hitch attachment, and a vertical stabilizer attached to the rear bumper of a vehicle according to a third embodiment of the current invention.

FIG. 16 is an isometric view of a pin according to one embodiment of the current invention.

### DETAILED DESCRIPTION

One embodiment of the current invention contemplates attaching the survey pole to the outside of a truck. Such an embodiment would enable a surveyor to keep the survey equipment powered on, thereby reducing or eliminating the need to recycle the equipment between survey locations. The embodiment would typically be attached at or near a pick-up truck bed.

A typical embodiment is located between the truck bed and the cab. By locating the embodiment at the truck bed, the current embodiment will not be damaged upon opening and closing the truck door. Therefore, the GPS and survey equipment may have a longer lifespan than devices used with prior art vehicle attachment systems. Since the GPS and survey devices would be less frequently placed in the back of a truck bed, excessive rattling and deterioration of the device would be reduced. Additionally, by not coupling the survey or GPS pole to the door, the window is free from obstruction. Finally, the apparatus coupling all embodiments to the vehicle is generally more secure than prior art vehicle coupling devices.

All embodiments of the invention contemplate implementing at least one tube clamp to secure a GPS or survey pole to the holder. If the vehicle-mounted pole holder is located between the truck bed and the cab, which is contemplated in one embodiment, a surveyor can attach and detach the surveying equipment without leaving the cab by reaching out the window and back to the current embodiment.

In another embodiment, the GPS or survey pole holder is located at or near a rear wheel well. The particular embodiment would allow the surveyor to couple a vehicle-mounted pole holder to the vehicle frame that is accessible from the wheel-well. A coupling mechanism is typically used in the wheel well embodiment that attaches and detaches to and from the vehicle frame.

In yet another embodiment, a pole holder is attached to a trailer-hitch mount through a trailer hitch attachment. The trailer-hitch embodiment typically includes a hinge. The hinge allows the rod in particular embodiment to rotate from a substantially vertical position to a substantially horizontal position, the substantially horizontal position being generally parallel to the rear or front end of a pick-up truck, depending on the location of the trailer-hitch mount.

These embodiments supply a surveyor with options on where and how to couple the pole holder to a vehicle, instead of simply giving the survey the options of placing the survey pole in the cab or a truck bed, holding onto the survey pole through a window, or coupling the survey pole to the vehicle with a door pole-holder attachment.

### Terminology:

The term “rod” as used in this specification and the appended claims is meant to include solid and hollow tubes having rectangularly-shaped cross-sections, as well as cylindrically elongated members.

The term “vehicle-attachment bracket” as used in this specification and the appended claims refers to an element of each embodiment that is adapted to (i) extend the rod away from the vehicle, and (ii) couple the particular embodiment to the vehicle.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “integrate” or “integrated” as used in this specification and the appended claims refers to a blending, uniting, or incorporation of the identified elements, components or objects into a unified whole.

### First Embodiment of Vehicle-Mounted Pole Holder

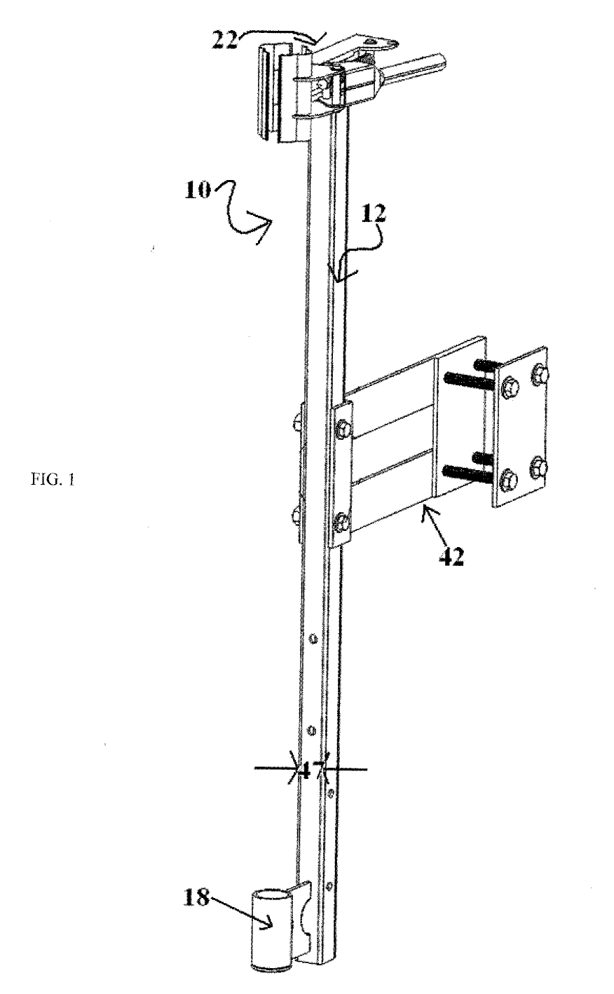

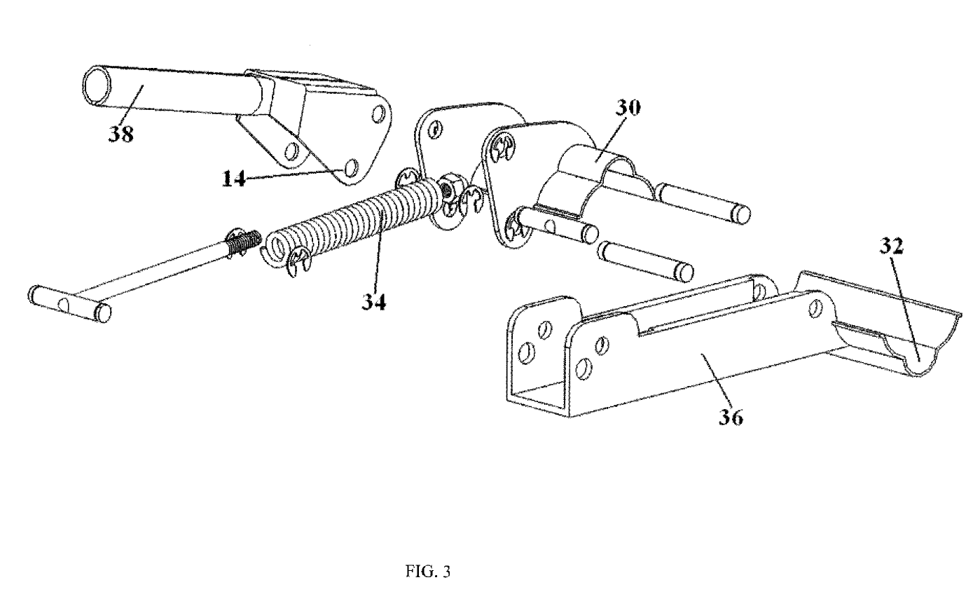

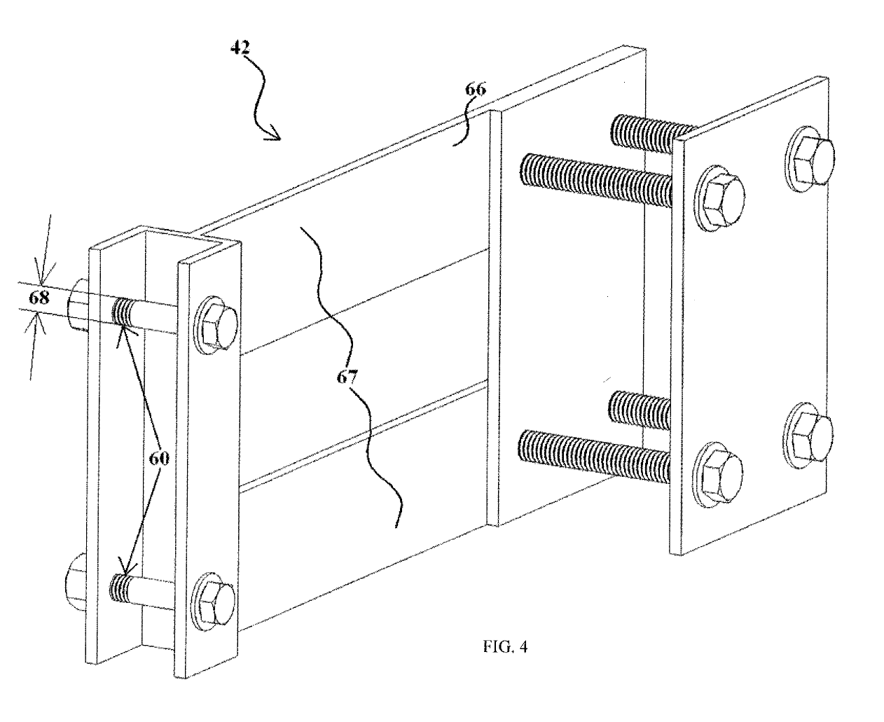

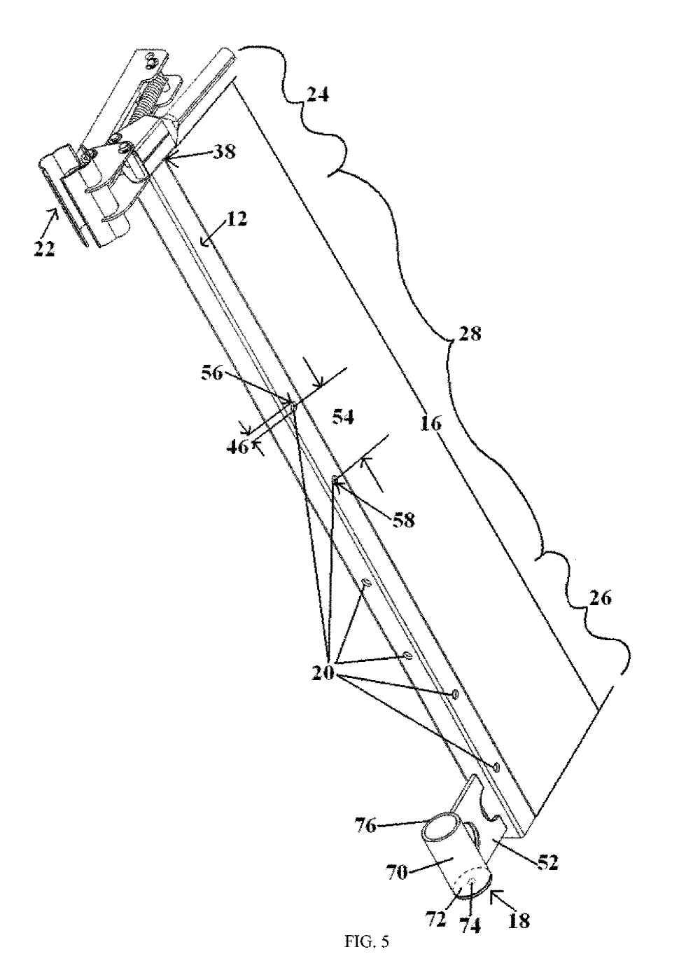

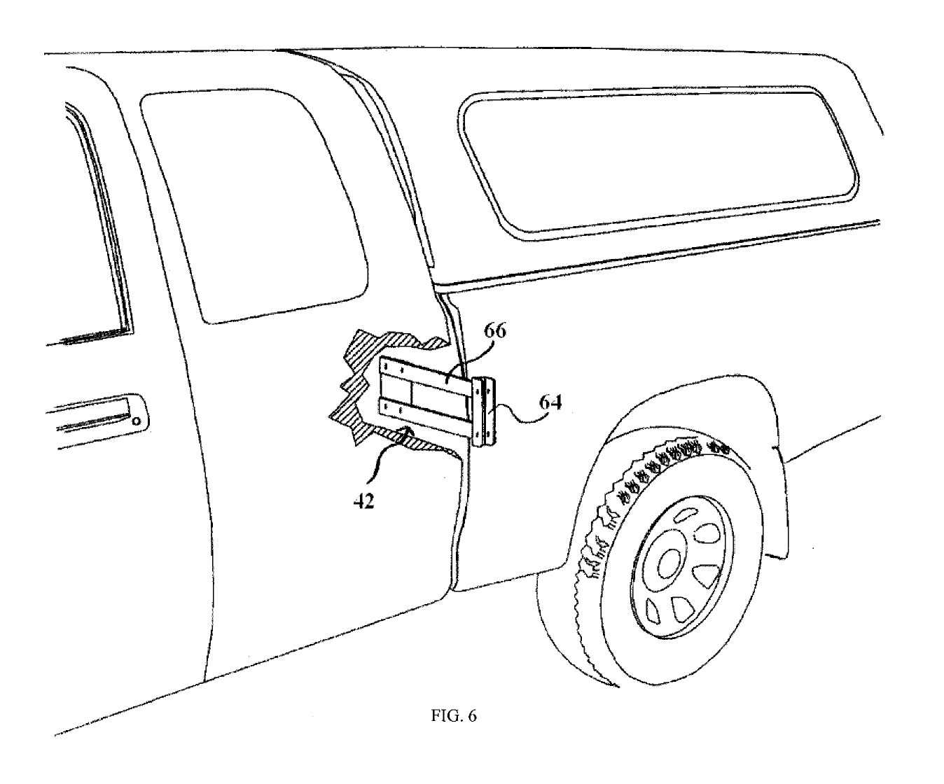

Referring to FIGS. 1 through 6 and FIG. 16, an embodiment of a vehicle-mounted pole holder 10 is illustrated. To ensure that the pole holder is durable, the pole holder may be comprised of metal such as aluminum or steel. The pole holder may also be constructed of another material, such as, but not limited to, a composite material. Lighter-weight materials may be used, although some of these materials may decrease the durability of the device.

The pole holder in the current embodiment is comprised of at least one rod 12. The main capabilities of the rod are to provide stability to the GPS or survey pole when the pole is attached to the vehicle. The rod may have a rectangular cross-section, although in variations the rod may have a circular or other geometricly-shaped cross-section. There is no standard rod length 16, although the rod is typically long enough to include a lower rest 18, at least one connection bore 20, and a tube clamp 22. The lower rest typically includes a tubular section 70 and a lower rest bracket 52. The tubular section typically includes a tube top 76, the tube top typically having a hole. A typical rod length may be approximately 60 inches. Alternative rod lengths may be as short as, or shorter than, 20 inches or as long as, or longer than, 100 inches.

A typical rod 12 that is cylindrical may have a cross-sectional diameter of generally 1.5 inches, although alternative embodiment rod diameters may be as small as 0.5 inches or as large as 6 inches. Where the rod has a rectangular cross-section, the length of a cross-sectional side is typically about 1.5 inches, but the cross-sectional side length may be as small as 0.5 inches, or as large as 6 inches.

No matter the size of the rod 12 in the current embodiment, each rod is typically comprised of a proximal section 24, a center section 28, and a distal section 26. The tube clamp 22 is typically located in the proximal section, the distal section is typically where the lower rest 18 is located, and the center section typically contains at least one connection bore 20. In alternative embodiments, both the tube clamp and the lower rest may be located in the center section. Additional connection bores are typically located at or near the distal section. Other embodiments may contain at least one connection bore at or near the proximal section. Finally, the tube clamp may be located in the distal section in some embodiments and the lower rest may be located in the proximal section.

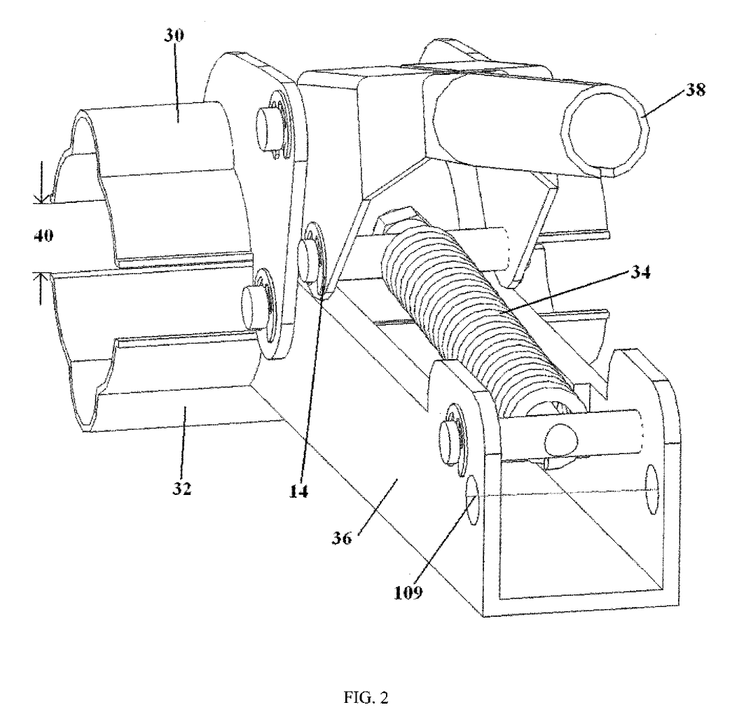

The tube clamp 22 in the current embodiment may be comprised of any suitable clamping device. Quick-release tube clamps are suitable for easy removal and field use, and may be used to release a survey or GPS pole while the surveyor is seated within the cab, which may be necessary upon adverse weather conditions quickly arising. The tube clamp as best illustrated in FIG. 2 typically comprises a body 36, a cam 14, and two jaws, the two jaws being an upper-jaw 30 and a lower-jaw 32. The upper and lower jaws typically have an arcuate inner surface.

A quick-release tube clamp 22 that does not contain jaws, such as, but not limited to, a magnetic clamping device, may be used. Additionally, the tube clamp may only contain upper 30 and lower 32 jaws without a body 36, or may contain only an upper jaw or only a lower jaw with or without a body. Some tube clamp jaws may not include arcuate inner surfaces. In at least one variation, the tube clamp is similar in operation and design to the tube clamps utilized by Park Tool Co. of St. Paul, Minn. in some of their bicycle repair stands.

Typically, one of the upper 30 and lower 32 jaws of the particular embodiment is coupled to the cam 14. In alternative embodiments, both the upper and lower jaws are coupled to a cam. Other embodiments may not incorporate a cam into the tube clamp. The cam is typically used to lock the jaws in a closed position, but in alternatives the cam may be used to lock the cam in an open position or in a different position not described herein.

The tube clamp 22 is also comprised of a handle 38. The handle, or other similar apparatus so adapted, is typically used to manually apply a force to the cam 14. In the current embodiment, applying a force to the handle in a direction towards the tube clamp body 36 sets the cam and closes the upper 30 and lower 32 jaws. Likewise, applying a force to the handle in a direction away from the body releases the cam and opens the jaws.

A tube clamp opening 40 is created between the upper 30 and lower 32 jaws when the upper and lower jaws are in the open position. The tube clamp 22 is typically positioned on the rod 12 such that, when the upper and lower jaws are open, the tube clamp opening between the jaws is positioned at least partially longitudinally outwardly from the rod and the vehicle. This is typically done for easy setting and removal of the GPS or survey pole to the pole holder 10. However, in alternative embodiments, the tube clamp opening may be directed generally towards the front or rear of the vehicle. If the tube clamp does not contain jaws, the opening is still typically positioned so the survey or GPS pole is secured to a side of rod opposite the vehicle or towards the front of the vehicle.

A typical surveyor will place a survey pole or GPS pole into the tube clamp 22 jaws while the clamp jaws are in the open position and subsequently press the handle 38 towards the body 36 to induce the cam 14, securing the pole to the rod 12. A spring 34, or other force-inducing device, such as, but not limited to, a latching mechanism or a pneumatic piston provides a force to the cam. The spring or other similar device helps to hold the handle in place, ensuring the cam is not released. One example of a Park Tool Co. tube clamp comprising a spring and suitable for use in the vehicle-mounted pole holder is Park Tool Item No. 100-1C: The Spring Linkage Tube clamp.

The pole holder also includes at least one vehicle-attachment bracket 42. The vehicle-attachment bracket typically includes at least one front surface 67. Typically, the front surface of the vehicle-attachment bracket and the body 36 of the tube clamp 22 are substantially parallelly aligned. However, in alternative embodiments where the tube clamp opening 40 generally faces the front or rear of the vehicle, the tube clamp body and the vehicle attachment front surface are not substantially parallel.

The tube clamp 22 is typically coupled to the proximal section 24 of the rod 12 through a weld. In the particular embodiment, the body 36 of the tube clamp is typically welded to the end 38 of the proximal section of the rod. However, in alternative embodiments, the body of the tube clamp may be welded to a different part of the rod, such the center section 28, the distal section 26, or another part of the proximal section of the rod.

Alternative embodiments may be comprised of tube clamps 22 that are not coupled to the rod 12 through a weld, but are coupled to the rod through an alternative method such as, but not limited to, a bolted assembly. The tube clamp may also be comprised of two clamping mechanisms—a tube clamp to clamp the rod and a tube clamp to clamp the survey pole—such a tube clamp would be a dual tube clamp device.

In addition to the tube clamp 22, the rod 12 is also comprised of at least one connection bore 20. In the typical embodiment, the rod is comprised of six connection bores 20. The two connection bores nearest the tube clamp 22 in the current embodiment are a first connection bore and a second connection bore, the first and second connection bores being adapted to allow the vehicle-attachment bracket 42 to couple to the rod. The vehicle-attachment bracket is also typically coupled to the vehicle through a vehicle-attachment bracket coupling apparatus. One type of coupling apparatus may be an apparatus such as, but not limited to, a bolt-plate assembly.

The two connection bores 20 nearest the tube clamp 22 are typically located in the rod center section 28. However, one or both of the connection bores may be located at either the rod proximal section 24 or rod distal section 26. Additional connection bores are typically located in the center section or distal section. The connection bores generally have a circular cross-section. However, the connection bores may be comprised of a rectangular or any other geometrically-shaped cross section.

In the typical embodiment comprising circular cross-section connection bores 20, the longitudinal axis of each connection bore is typically perpendicular to the longitudinal axis of the rod 12. The longitudinal axis of the two connection bores nearest the tube clamp 22 are also typically substantially perpendicular to the lower rest bracket 52 and the front surface 67 of the vehicle-attachment bracket 42. The perpendicular alignment between the two connection bores nearest the tube clamp, the lower rest bracket and the vehicle-attachment bracket front surface typically ensures that the GPS and survey poles are positioned away from the vehicle. However, in other embodiments, the longitudinal axis of the connection bores may not be perpendicular to the lower rest bracket.

In the typical embodiment, a diameter 46 of a typical cylindrical connection bore is generally 0.75 inches, although alternative embodiments may increase or decrease the size of the connection bore diameter between 0.125 and 4 inches. A connection bore with a rectangular cross-section may generally have a cross-section side length of 0.75 inches, although other embodiments may increase or decrease the length of the rectangular cross-section side between 0.125 and 4 inches.

In the typical embodiment containing two connection bores 20 that couple to the vehicle-attachment bracket 42, the distance 54 between the upper vehicle-attachment connection bore 56 and the lower vehicle-attachment connection bore 58 is typically adapted such that the vehicle-attachment bracket 42 may be mounted on the outside of a pick-up truck bed front sidewall. The vehicle-attachment bracket is typically coupled between the bed and the cab. It is to be appreciated that in alternative embodiments, vehicle-attachment brackets may be coupled to the sidewall of a pick-up truck bed not between the cab and the bed, or may be coupled to the side of a vehicle that is not a pick-up truck, such as, but not limited to, a sport-utility vehicle, or may be coupled to the cab of a pick-up truck. However, in the typical embodiment, the distance between the upper and lower vehicle attachment connection bores is generally not greater than the distance between the top and lower edges of the pick-up bed front sidewall. A typical distance between connection bores is generally 12 inches. In other embodiments, the distance may be as small as 3 inches or as great as 40 inches.

Each connection bore 20 in the particular embodiment is typically adapted to receive a threaded bolt. The first connection bore typically receives a first bolt and the second connection bore typically receive a second bolt. However, in alternative embodiments, each connection bore may receive a pin 62. Whether a bolt or pin is used, the bolt or pin typically has a substantially circular cross-section. The connection bore typically extends through the width 47 of an arm side. In variations, the bolt may not be substantially circular, but may be a shape such as, but not limited to, a rectangular shape.

Each connection bore 20 is typically coupled to a vehicle-attachment bracket 42. In the current embodiment, the vehicle-mounted bracket 42 consists of a first portion 64 and a second portion 66. The first portion is typically a three-sided bracket adapted to receive the rod 12. Two sides of the bracket typically include two bores adapted to receive a threaded bolt or a pin 62. The two bores 60 in the first portion are a first bracket bore and a second bracket bore, each bore typically having a diameter 68 generally the same size as the connection bore diameter 46. The first portion bores are also typically is adapted to receive a pin 62 or threaded bolt. Additionally, the first portion and rod typically have similar cross-sectional geometries. That is, both the rod and the first portion cross-sections would likely be generally circular, or both may be generally rectangular.

Being able to quickly attach and detach the rod 12 to the vehicle is a useful feature of the current embodiment. Many surveyors will not want the rod attached to the outside of the vehicle unless they are performing a survey. Therefore, most surveyors will typically want to quickly and easily attach and detach the rod to and from the vehicle before and after a survey is taken, respectively.

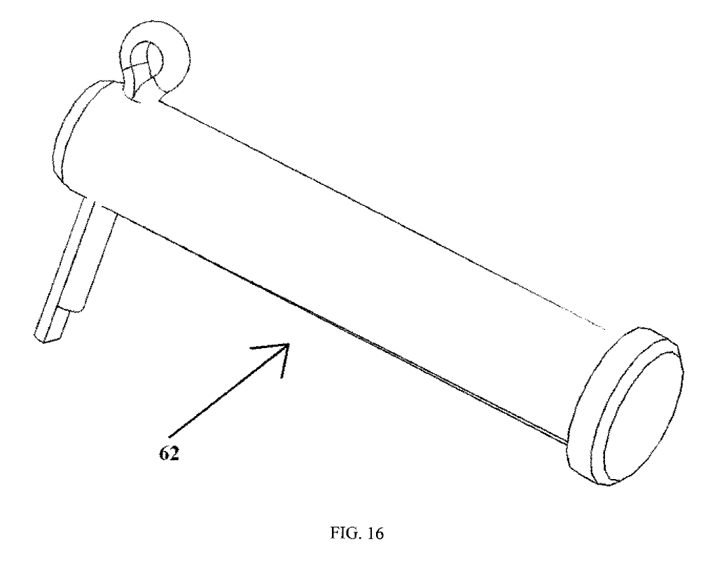

To couple the rod 12 to the vehicle-attachment bracket 42, the first portion 64 of a vehicle attachment bracket 42 typically receives the rod. The two connection bores 48 nearest the tube clamp 22 and the first portion bores 60 are aligned. A first pin 62 (as best shown in FIG. 16) or fist bolt is placed through one aligned first portion bore and connection bore. A second pin 62 or second bolt is placed through a second first portion bore and connection bore. The pins or bolts typically ensure the rod does not become uncoupled from the vehicle-attachment brackets. Other embodiments may include a cotter pin or a clevis pin.

The second portion 66 of the vehicle-attachment bracket typically consists of an upper bracket and a lower bracket. The second portion upper bracket is coupled to the vehicle through at least one vehicle attachment bracket coupling apparatus. The second portion lower bracket is also coupled to the vehicle through at least one bracket coupling apparatus. The upper and lower bracket coupling apparatus may be apparatus such as, but not limited to, bolted plate assemblies. Typically, the vehicle-attachment bracket is coupled to a vertical front sidewall of a pickup truck.

In the lower rest 18, the tubular section 70 is generally a circular tube and includes a tube bottom 72. The tube bottom is typically partially open. In alternative lower rests, the tubular section may be generally rectangular or any other suitable shape.

The typical lower rest tube bottom 72 generally includes a lower rest bottom bore 74. The longitudinal axis of the bottom bore is typically substantially perpendicular to the tube bottom and is generally parallely aligned with the longitudinal axis of the tubular section 70. In other embodiments, the tube bottom may not include a bore, may include a bore that is not generally circular, or may include a bore longitudinal axis that is not parallelly aligned with the longitudinal axis of the tubular section.

In other embodiments, the tubular section 70 of the lower rest 18 may not include a tube bottom 72. The tube top 76 in the particular alternative may be of a greater diameter than the tube bottom 72. No matter the design of the tubular section in the current embodiment, the tubular section is adapted in such a way that a survey or GPS pole may be placed within the tubular section. Additionally, the tubular section generally stabilizes the survey or GPS pole together with the generally aligned tube clamp.

### Second Embodiment of Vehicle-Mounted Pole Holder

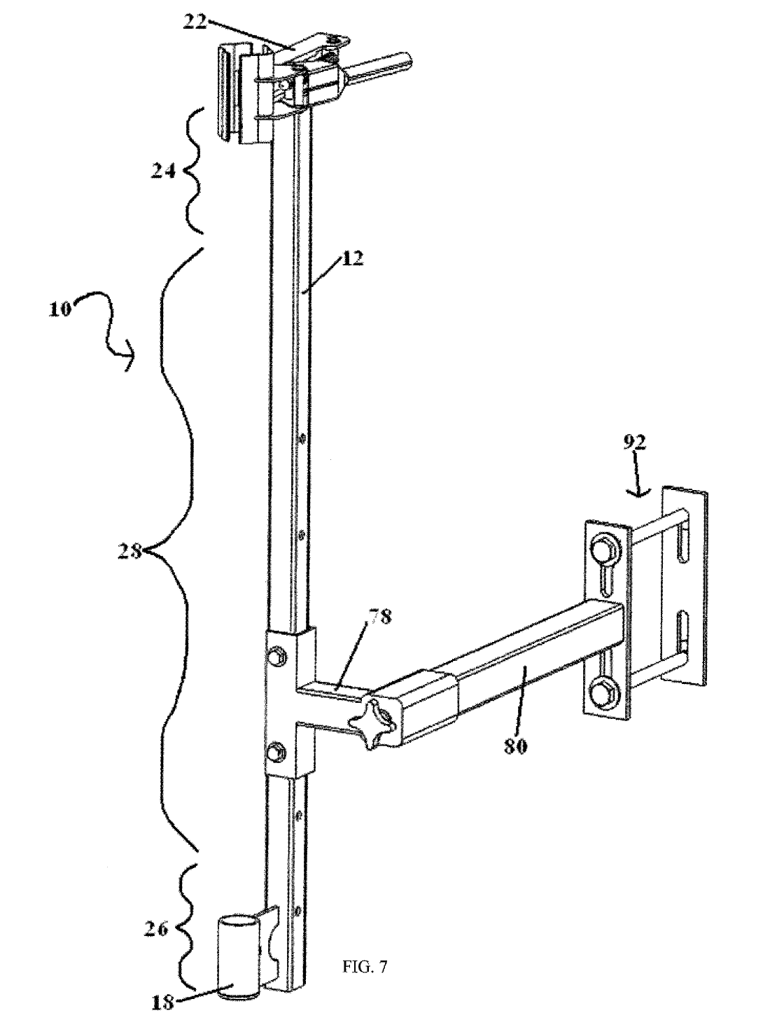

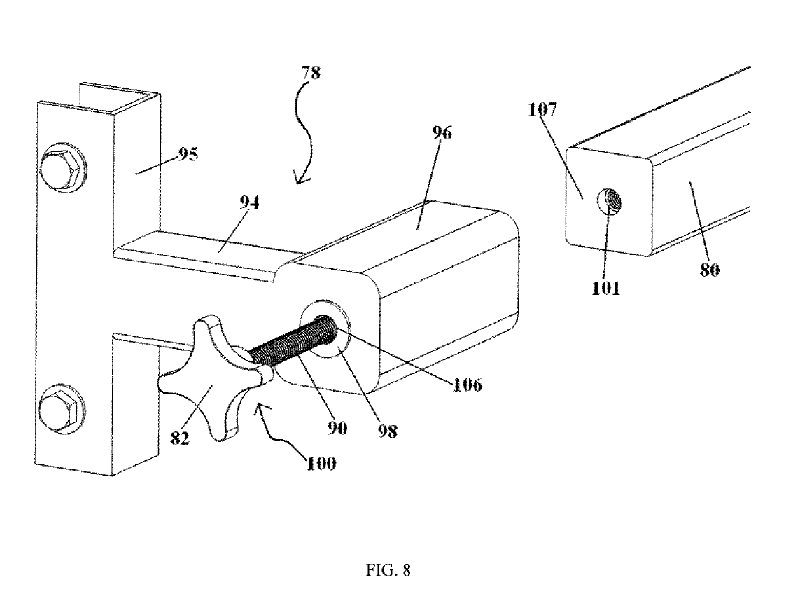

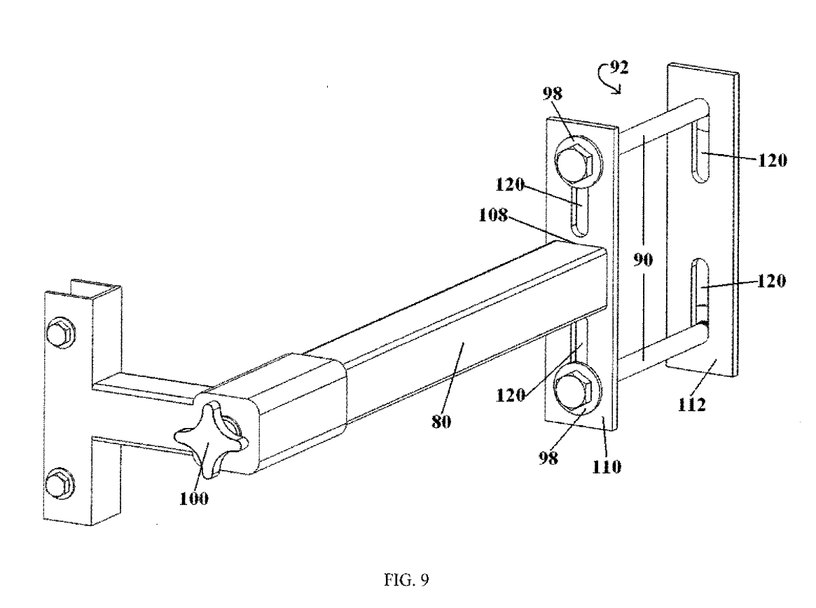

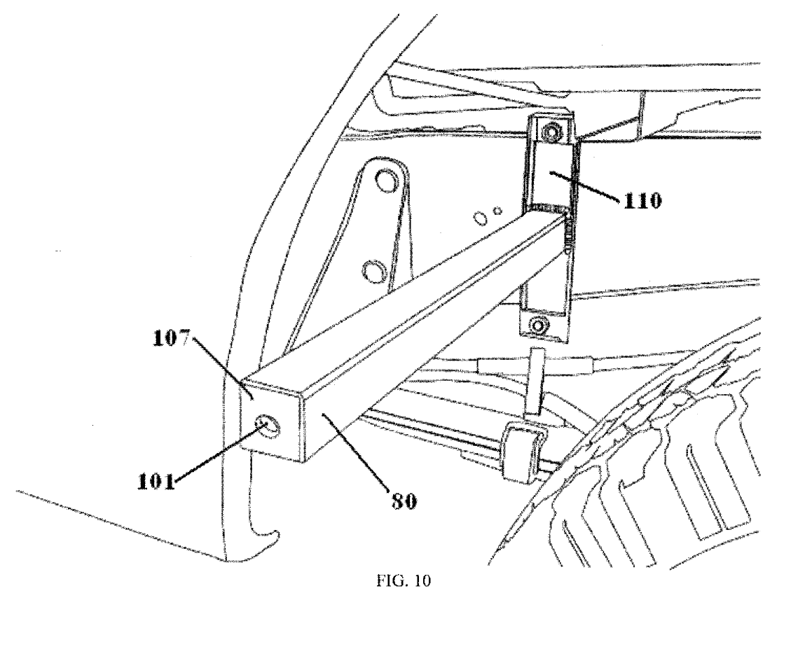

Referring to FIGS. 7 through 10 and FIG. 16, another embodiment of a vehicle-mounted pole holder 10 is illustrated. The current embodiment is comprised of a substantially similar material as the first embodiment. The current embodiment is also typically comprised of a rod 12, and a pole attachment mechanism. The pole attachment mechanism typically is a tube clamp 22 and a lower rest 18. The rod, tube clamp and lower rest are all substantially similar to the first embodiment.

The particular embodiment also includes a vehicle-attachment bracket 78, a connection arm 80, a blackplate section 92, and a locking mechanism 100. The vehicle-attachment bracket is comprised of a bracket first section 94, a bracket second section 96, and a bracket third section 95. As in the first embodiment, the vehicle attachment bracket is adapted to couple the rod to the vehicle. The bracket third section is substantially similar to the first portion of the vehicle attachment bracket in the first embodiment. The bracket first section extends generally longitudinally outwardly from the rod 12, being substantially perpendicular to the rod's longitudinal axis. The bracket third section is typically coupled to the rod at the rod center section 28. In alternative embodiments, the bracket first section may not extend substantially perpendicular to the rod's longitudinal axis or the vehicle attachment bracket third section may be coupled at the rod proximal section 24 or rod distal section 26, or may be integrated to the rod.

The bracket second section 96 extends substantially perpendicular from both the bracket first section 94 and the rod's longitudinal axis. In alternative embodiments, the bracket second section does not extend substantially perpendicular to the bracket first section or the rod's longitudinal axis or may be a shape such as, but not limited to, a curved second section.

The current embodiment's vehicle-attachment bracket 78 is typically at least partially hollow and has a cross-sectional area that is typically substantially rectangularly-shaped, the rectangular cross-section typically having beveled corners. At least a portion of the current embodiment's arm 80 is also hollow and rectangularly shaped. A bracket second section cross-sectional side length is typically generally 1.5 inches in length, although in alternative embodiments, a bracket second section cross-sectional side length may be only 12.5 inches or up to 3 inches in length. Whatever the bracket second section cross-sectional side length, the bracket side length is typically greater than the arm side length because at least a portion of the arm is placed within the bracket second section 96 in the current embodiment. In alternative embodiments, at least a portion of the vehicle-attachment bracket is placed within the arm.

In the current embodiment, the vehicle-attachment bracket 78 locking mechanism 100 includes a knob 82, a washer 98, and a bolt 90. The locking mechanism is adapted to couple the vehicle attachment bracket, rod, and GPS or Survey pole to the connection arm 80.

The knob 82 in the current embodiment is coupled to the bolt 90, the coupled knob and bolt being a tightening apparatus. The knob and bolt are coupled through a method such as, but not limited to, the knob having a recessed section within the top surface of the knob that is sized such that the bolt head fits securely within the recessed section. Alternative embodiments may not include a knob, but may include a device such as, but not limited to, a lever. Additionally, other embodiments may couple the bolt to the knob through methods such as, but not limited to, applying an adhesive substance to the bolt head and the knob, or by integrating the knob and the bolt head.

The washer 98 is typically placed on the bolt 90. The bolt is subsequently placed through a hole 106 located in the bracket second section 96 such that the washer is typically substantially flush with the bracket second section. The tightening apparatus is adapted to thread the bolt into a threaded hole 101 in the arm 80 adapted to receive the bolt therein. The bolt 90 is therefore typically longer than the combined length of the washer 98 and the bracket second section 96.

In the current embodiment, a portion of the arm 80 is slid into a portion of the vehicle-attachment bracket 78. The arm is typically inserted into the bracket up to the point where at least a portion of the bracket first section 94 is generally flush with the arm end 107. However, the arm may be inserted to the bracket only up to any point where the arm endpoint 107 rests at any point along the bracket second section 96.

Additional alternative embodiments may not use a locking mechanism 100 with a tightening apparatus to couple the vehicle-attachment bracket 78 to the connection arm 80, but may use a locking mechanism that includes a pin or a bolt, similar to the connection bore 20 and pins 62 or bolts employed in the first embodiment. Locking mechanisms in alternative embodiments may also include a cotter pin or a clevis pin.

The connection arm 80 in the current embodiment includes a distal connection arm endpoint 108. Additionally, the backplate section 92 in the current embodiment is comprised of one or more backplates, the backplate section typically having a first backplate 110 and second backplate 112, with the distal arm endpoint typically being integrated to the first backplate. The integration typically occurs with a weld, but the integration may also be through a mold of the arm and first plate.

The first 110 and second 112 backplates are typically coupled together through at least one coupling apparatus. A coupling apparatus such as, but not limited to, a bolted assembly may be used. The bolted assembly includes at least one nut, one bolt 90, and one washer 98. In the current embodiment, two coupling apparatus couple the first and second backplates together.

The first backplate 110 and second backplate 112 also include at least one slot 120. To couple the present embodiment to the vehicle, the first plate is adapted to mount substantially flush with the vehicle frame at a vehicle frame first side, typically in a rear wheel-well. The driver's side rear wheel-well may be used, but any wheel-well may also be used. The second backplate is placed substantially flush with a vehicle frame second side.

When the first backplate 110 is placed substantially flush with the vehicle frame first side, a bolt 90 is placed through a washer 98 and through a slot 120 of the first plate. The bolt is then placed through a slot on the second plate 112 and the second plate is placed substantially flush with a vehicle frame second side. A washer is then placed on the bolt, and a nut is threaded onto the bolt. Each plate on the current embodiment typically has two slots, each slot being generally vertically oriented. A bolted assembly is placed through each of the slots in the current embodiment. Each nut is tightened until the second plate is substantially flush with, and coupled with, the vehicle frame.

### Third Embodiment of Vehicle-Mounted Pole Holder

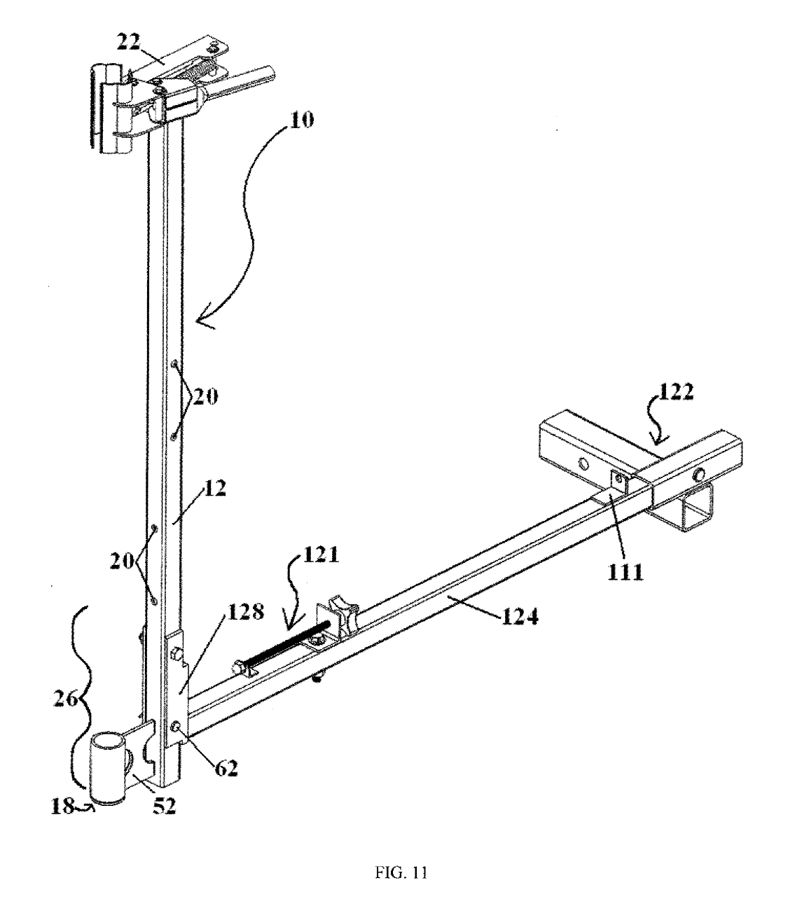

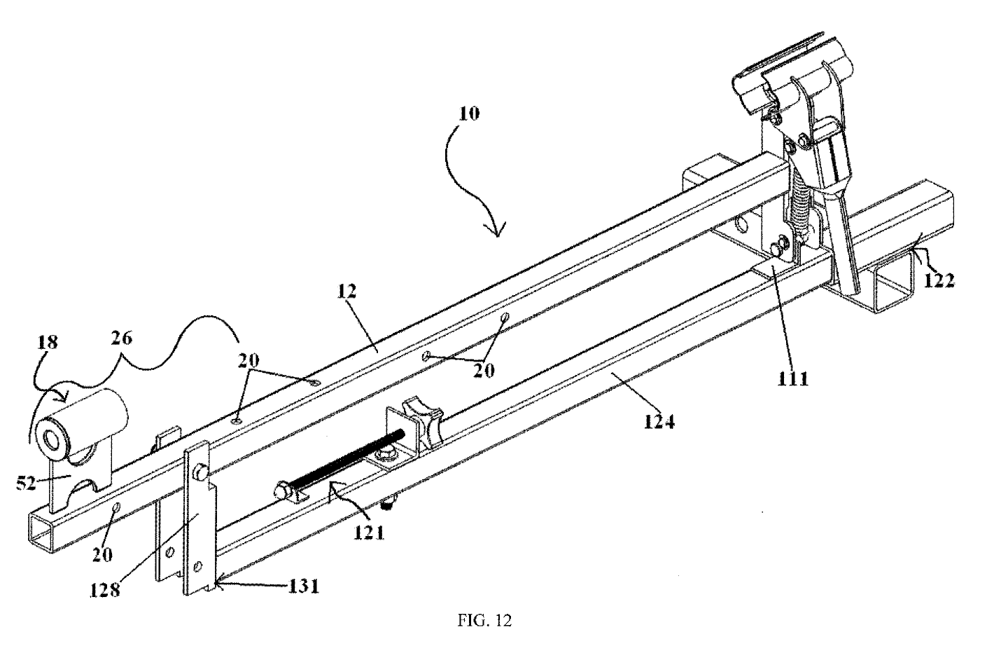

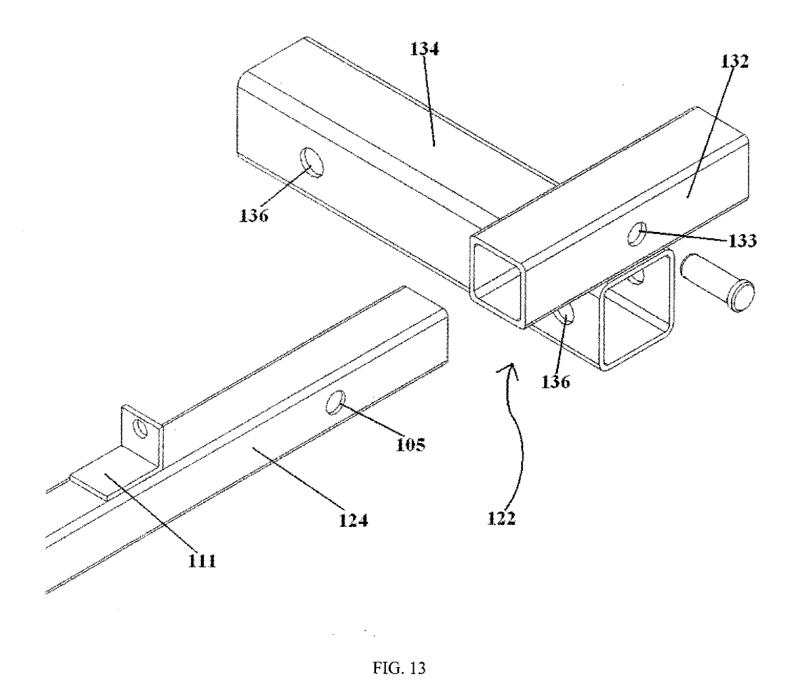

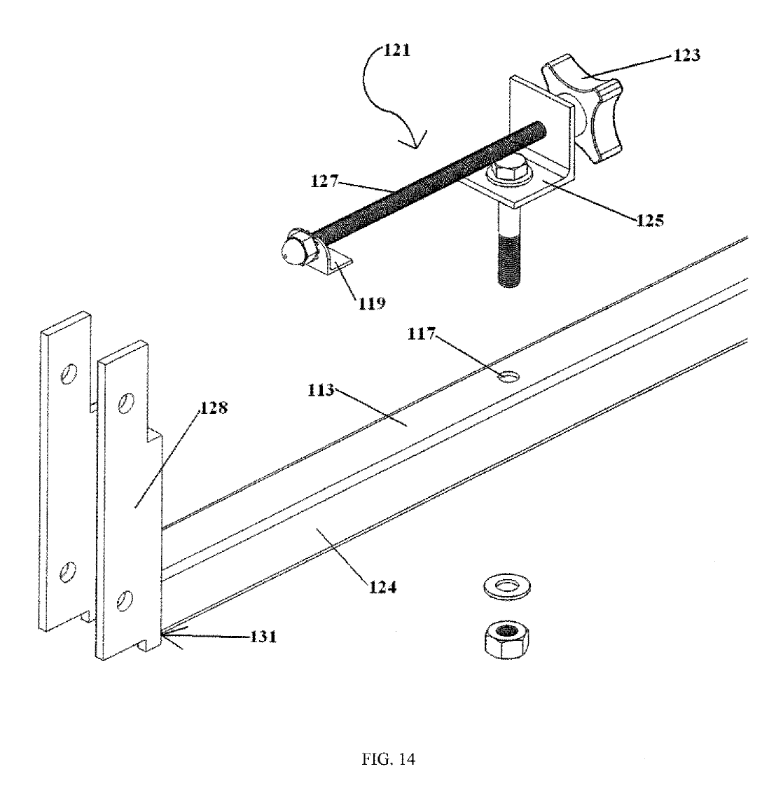

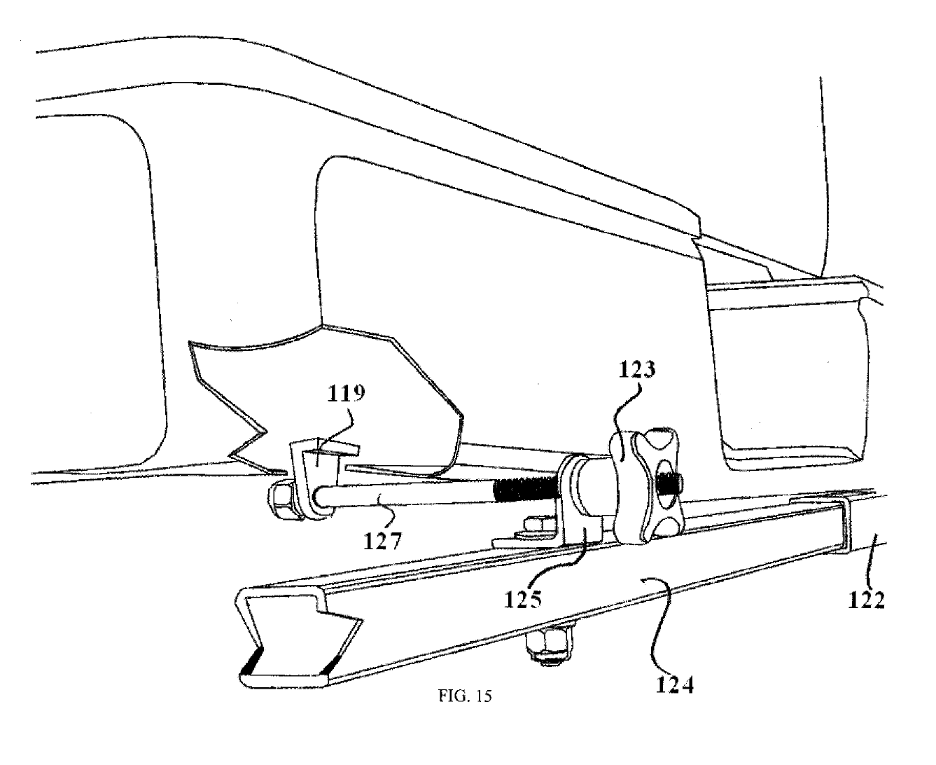

Referring to FIGS. 11 through 16, an embodiment of a vehicle-mounted pole holder 10 is illustrated. The particular embodiment is comprised of a substantially similar material as the first and second embodiments. Additionally, the current embodiment is comprised of a rod 12, and a pole attachment mechanism. The rod is substantially similar to the first and second embodiments, typically including at least one connection bore 20 and at least one pin 62. The pole attachment mechanism is typically a tube clamp 22 and a lower rest 18, tube clamp and lower rest also being substantially similar to the first and second embodiments. In alternative embodiments, the pole attachment mechanism is not a lower rest and tube clamp, but is a mechanism such as, but not limited to, a magnetized pole attachment mechanism.

In general, the third embodiment of the current invention is an embodiment adapted to couple to the trailer hitch mount of a pick-up truck, or any other vehicle possessing a trailer-hitch mount, through a trailer-hitch attachment 122. The current embodiment also includes a hinge 128. The hinge is typically adapted to allow the rod 12 to rotate from a substantially vertical position to a substantially horizontal position. The current embodiment may attach to a trailer hitch located at the rear end or the front end of a vehicle.

In addition to the rod 12, tube clamp 22, lower rest 18, trailer-hitch attachment 122, and hinge 128, the current embodiment includes a vehicle-attachment bracket 124. The vehicle attachment bracket is typically adapted to couple the rod to the vehicle by coupling to the trailer-hitch attachment. In alternative embodiments, the vehicle-attachment bracket and trailer-hitch attachment are integrated or the trailer-hitch attachment may extend and couple directly to the rod or pole. In the current embodiment, the vehicle attachment bracket is also typically generally parallel to the front end or rear end of a vehicle, depending on the trailer hitch location.

In the current version of the embodiment, the hinge 128 is coupled to both the vehicle-attachment bracket 124 and the rod 12. Typically, the hinge is coupled to the vehicle attachment bracket 124 at a vehicle attachment bracket end 131. The hinge is typically coupled to the rod at a rod distal section 26. In alternative embodiments, the hinge is coupled to the vehicle attachment bracket or to the rod at different locations.

The hinge 128 is adapted to allow the rod 12 to rotate from a substantially vertical position to a substantially horizontal position, the substantially horizontal position of the arm typically being substantially parallel and typically planar to the vehicle-attachment bracket 124. The current embodiment also typically includes a vertical stabilizer 121 to keep the vehicle attachment bracket from moving in a vertical direction upon placement into the vehicle's trailer hitch mount. One type of vertical stabilizer includes a knob 123, a bracket 125, a bolt 127, and a latch 119. However, other types of vertical stabilizers are contemplated, such as, but not limited to, a horizontal stabilizer that is coupled to the trailer-hitch attachment 122.

In the current embodiment, the vertical stabilizer 121 is coupled to the vehicle attachment bracket 124. Typically, the vehicle attachment bracket includes a bore 117. The bore is typically generally circular and extends through the top surface 113 of the vehicle-attachment bracket. The bore also typically extends through any surface opposing the top surface of the vehicle-attachment bracket—typically a bottom surface. The bore's longitudinal axis is typically perpendicular to the top and bottom surfaces of the vehicle attachment bracket.

The bracket 125 typically includes two bores. A first bore is adapted to allow the bolt 127 to pass through the bore. The latch 119 is placed on the end of the bolt. The second bore in the bracket is aligned with the bore 117 on the top surface 113 and bottom surface of the vehicle-attachment bracket 124. A bolted assembly or a pin 62 is typically used to couple the bracket to the vehicle-attachment bracket.

To actuate the vertical stabilizer 121, upon the vehicle-attachment bracket 124 being coupled to the trailer-hitch attachment 122, the bracket 125 is rotated such that the latch 119 is located closer to the bumper. As the knob 123 is typically coupled or integrated to the bolt 127, the knob is turned in order to hook the latch to the underside of the bumper.

The vehicle-mounted pole holder 10 also typically includes a horizontal securement mechanism 111. The horizontal securement mechanism is typically a bracket including a bore. However, alternative embodiments may include a horizontal securement mechanism that is a device such as, but not limited to, a clamp. In the preferred embodiment, the rod is secured in a horizontal position by removing a pin 62, bolt, or any other similar device from the connection bore 20 nearest the lower rest 18, rotating the rod to a horizontal position and placing the pin or other similar device through the bracket bore and a bore 109 on the tube clamp 22 adapted to receive the pin or other similar device. In alternative embodiments, the rod 12 may be secured in a horizontal position by not coupling the rod to the vehicle attachment bracket 24, or using a different device to couple the rod to the vehicle-attachment bracket.

Typically, at least a section of the vehicle attachment bracket 124 is a rod-like section with generally a rectangular cross-sectional area. The hinge 128 is typically comprised of 3 sides. However, it is to be appreciated that the hinge may be any cross-sectional area and geometric shape that is adapted to allow the rod 12 to rotate from a generally vertical position to a generally horizontal position, or vice versa.

In the current embodiment, the typical length of the hinge is such that when the vehicle-attachment bracket 124 is placed in the horizontal position, the tube clamp bore 109 is substantially aligned with the bracket 111 bore. Likewise, the connection bore 20 that the pin 62 is placed through to couple the hinge 128 to the rod 12 is located on the rod at a distance from the tube clamp such that when the rod is in the horizontal position, the tube clamp bore 109 is substantially aligned with the bracket 111 bore. The hinge is coupled to the rod through connection bores substantially perpendicular to the lower rest bracket 52. In alternative embodiments the hinge is of a length that is not adapted to place the tube clamp bore 109 substantially in line with the bracket 111.

The vehicle-attachment bracket 124 typically extends from a position generally near the front or rear driver-side bumper corner to a position past a trailer hitch. In other embodiments, the second section extends from a position generally near the front driver-side bumper corner to a position near a trailer hitch such that the vehicle attachment bracket may be coupled to the trailer-hitch attachment 122. The typical length of the vehicle-attachment bracket is generally 40 inches, but alternate embodiments are contemplated that require longer or shorter distances. Many times, the vehicle attachment bracket size will depend on the width of the truck bed or the vehicle front or rear end. Also, in alternative embodiments, the vehicle attachment bracket may extend from a position near the front or rear passenger-side bumper corner to a position past the trailer hitch.

In the current embodiment, whatever the length of the vehicle-attachment bracket 124, the end of the vehicle-attachment bracket nearest the trailer hitch attachment 122 includes at least one bore 105. The bore typically is a horizontal bore which extends through the front and back surfaces of the bracket, although in alternative embodiments, there may be more than one bore or the bore may be generally vertical.

The longitudinal axis of the typical bore 105 is substantially perpendicular to the front and back surfaces of the vehicle attachment bracket, although in alternative embodiments, the longitudinal axis may not be perpendicular to any surface of the bracket. The bore is typically a circular bore, although in alternative embodiments, the bore is not a circular bore, but the bore is a shape such as, but not limited to, a rectangular bore. The typical bore diameter is generally 0.75 inches, although embodiments may have a bore diameter as small as 0.125 inches or as large as 4 inches. If the bore is a rectangular-shaped bore, the length of a side of the rectangle is generally 0.75 inches, although the length of a side of the rectangle may be as small as 0.125 inches or as large as 4 inches.

To couple the vehicle-attachment bracket 124 and coupled rod 12 to the vehicle in both versions, the end of the vehicle-attachment bracket 124 typically slides into the trailer-hitch attachment 122. Therefore, the outside length of a cross-sectional side of the vehicle attachment bracket is typically smaller than the inside length of a cross-sectional side of the trailer-hitch attachment.

The trailer hitch attachment 122 typically includes a first section 132. The first section is integrated with a second section 134 of the trailer hitch attachment. The first and second sections are typically integrated with a weld, but in alternative embodiments, the two sections are integrated through a different mechanism, or may be coupled to each other. The first and second sections typically have substantially similar rectangular cross-sections. The first section is typically perpendicular to the second section. Additionally, the center portion of the bottom surface of the first section is typically welded to the top portion of the top surface of the second section, generally forming a “T”.

The second section 134 of the trailer-hitch attachment 132 also typically includes at least one bore 136. In the particular embodiment, there are usually two horizontal bores through the side surface of the second section. The second section typically couples to the trailer-hitch of a vehicle by sliding into the trailer hitch and placing a pin 62 is through at least one of the second section bores and a correspondingly aligned vehicle trailer hitch mount bore. Alternative coupling mechanisms such as, but not limited to, a different type of clevis pin or a cotter pin may also be used.

The length of the trailer-hitch attachment 122 second section 134 is typically longer than the first section 132. The current embodiment's second section is generally 2 times the length of the first section. However, in alternative embodiments, the second section may only be as long as the first section, or may even be shorter than the first section, or the bore in the second section may be substantially vertical, dissecting the top and bottom surfaces of the second section.

The trailer hitch attachment 122 first section 132 also typically includes a bore 133. The first section bore is typically a horizontal bore located near the center of the first section. In alternative embodiments, the first section includes two bores, or the bore may be a horizontal bore. The total length of the trailer-hitch attachment first section is typically 8 inches, although some first sections may be only 4 inches and other first sections may be as long as 24 inches.

### Alterative Embodiments and Other Variations

The embodiments of the vehicle-mounted pole holder as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure. For instance the embodiments are described herein primarily in relation to a truck or a pickup-style truck. It is appreciated, however, that variations can be attached to other types of automobiles, ATVs and other motorized vehicles.

I claim:

1) A vehicle-mounted pole holder comprising:
a rod, the rod including a tube clamp, a lower rest and one or more vehicle-attachment brackets;
the tube clamp including at least two jaws and a cam;
the lower rest including a hole;
the one or more vehicle-attachment brackets being adapted to couple the rod to the vehicle.

2) The vehicle-mounted pole holder of claim 1, the tube clamp further including (i) a body, the body being coupled to at least one jaw, (ii) a handle, the handle adapted to activate and release the cam, and (iii) a spring, the spring adapted to apply a force to the cam.

3) The vehicle-mounted pole holder of claim 1, the lower rest adapted to receive and stabilize a pole placed within the hole.

4) The vehicle-mounted pole holder of claim 1,
the rod further including first and second connection bores;
the one or more vehicle attachment brackets having a first portion and a second portion, the second portion having an upper bracket and a lower bracket;
the first portion of each bracket being coupled to at least one of the first or the second connection bores, and
the second portion of each bracket adapted to be coupled to the vehicle.

5) The vehicle-mounted pole holder of claim 4 further comprising first and second bolts, and first and second bracket bores extending through the respective first portion of the vehicle attachment bracket; and wherein,
the first bracket bore is adapted to align with the first connection bore and receive the first bolt therethrough;
the second bracket bore is adapted to align with the second connection bore and receive the second bolt therethrough.

6) The vehicle-mounted pole holder of claim 5 further including at least one vehicle-attachment bracket coupling apparatus; and wherein,
the second portion of the vehicle-attachment bracket and adapted to couple to a vertical front sidewall of a pick-up truck bed through at least one vehicle-attachment bracket coupling apparatus.

7) The vehicle-mounted pole holder of claim 1 further including one or more backplates, a connection arm, and a locking mechanism.

8) The vehicle-mounted pole holder of claim 7 wherein,
the locking mechanism couples the vehicle attachment bracket to the connection arm;
the connection arm is integrated to one or more backplates; and
the one or more backplates comprising a first backplate and a second backplate, and including at least one coupling apparatus.

9) The vehicle-mounted pole holder of claim 8 wherein,
the locking mechanism includes a tightening apparatus, the tightening apparatus having a knob and a bolt;
the connection arm being adapted to receive the bolt upon tightening.

10) The vehicle-mounted pole holder of claim 9 wherein,
at least a portion of the vehicle attachment bracket is hollow; and
at least a portion of the connection arm, and at least a portion of the tightening apparatus are placed within the vehicle attachment bracket hollow portion.

11) The vehicle-mounted pole holder of claim 8 wherein, at a rear wheel-well, the first blackplate is adapted to mount substantially flush with a vehicle frame first side, the second backplate is adapted to mount substantially flush with a vehicle frame second side, and the two coupling apparatus are adapted to couple the first backplate and the second backplate to the vehicle frame.

12) The vehicle-mounted pole holder of claim 1 further including a trailer-hitch attachment, the trailer-hitch attachment being adapted to couple the vehicle-attachment bracket to a trailer hitch mount of the vehicle.

13) The vehicle-mounted pole holder of claim 12 further including a hinge, the hinge being coupled to the rod and the vehicle-attachment bracket, and adapted to rotate the rod between a substantially vertical position to a substantially horizontal position.

14) The vehicle-mounted pole holder of claim 13 further including a vertical stabilizer.

15) A vehicle-mounted pole holder comprising:
a rod, the rod including a pole attachment mechanism;
a trailer hitch attachment; and
a vehicle attachment bracket adapted to couple the rod to the trailer hitch attachment.

16) The vehicle-mounted pole holder of claim 15, further including a hinge, the hinge being coupled to the rod and the bracket and adapted to rotate the rod from a substantially horizontal position to a substantially vertical position.

17) The vehicle-mounted pole holder of claim 16 wherein, the vehicle attachment bracket being substantially parallel to the rod horizontal position.

18) A vehicle-mounted pole holder comprising:
a rod, the rod including a pole attachment mechanism;
a connection arm, the connection arm being coupled to a vehicle;
a vehicle attachment bracket, the vehicle attachment bracket being coupled to the rod and including a tightening tool, the tightening tool being adapted to couple the vehicle attachment bracket to the arm;

19) The vehicle-mounted pole holder of claim 18 wherein,
the pole attachment mechanism being a tube clamp and a lower rest, the lower rest being adapted to receive the end of a survey pole;
the connection arm being integrated to a first backplate, the first backplate adapted to couple to a vehicle frame and a second backplate; and
the vehicle attachment bracket having a hollow portion,
at least a portion of the connection arm and the tightening tool being adapted to be placed in the vehicle attachment bracket hallow portion.

20) The vehicle-mounted pole holder of claim 19 wherein,
the tightening tool having a bolt; and
the connection arm having a bore, the bore adapted to receive the bolt upon tightening of the tightening tool.
